(19) United States
(12) Patent Application Publication
(10) Pub. No.: US 2020/0339002 A1
(43) Pub. Date: Oct. 29, 2020

(54) METHOD FOR CHARGING A TRACTION BATTERY OF AN ELECTRICALLY POWERED MOTOR VEHICLE

(71) Applicant: VOLKSWAGEN AKTIENGESELLSCHAFT, Wolfsburg (DE)

(72) Inventor: Matthias BÖTTGER, Braunschweig (DE)

(73) Assignee: VOLKSWAGEN AKTIENGESELLSCHAFT, Wolfsburg (DE)

(21) Appl. No.: 16/861,822

(22) Filed: Apr. 29, 2020

(30) Foreign Application Priority Data
Apr. 29, 2019 (DE) 10 2019 206 125.7

(51) Int. Cl. B60L 53/62; B60L 53/31; B60L 58/13; B60L 53/14

(52) U.S. Cl. CPC B60L 53/62; B60L 53/14; B60L 58/13; B60L 53/31

(57) ABSTRACT

A method for charging a traction battery (2) of an electrically powered motor vehicle (4), in which a first target value (S₁) for a first battery charge level (SOC₁) is specified for a start of the motor vehicle (4) in which the traction battery, provided that its battery charge level (SOC_{V}) is smaller than a second target value (S₂), to avoid aging processes, is charged in a first charging process (L₁) to a second battery charge level (SOC₂) which corresponds to a second target value (S₂), which second battery charge level (SOC₂) is smaller than the first battery charge level (SOC₁), and in which the traction battery (2) in a second charging process (L₂) is charged to the first battery charge level (SOC₁), wherein the start time (t_{S}) of the second charging process (L₂) is set as a function of a specific departure time (t_{A}), the first target value (S₁) and the second target value (S₂), or wherein the second charging process (L₂) is started on the basis of a start signal (S) which is output by the user as a result of an interaction of the user with a terminal (8). The invention further relates to a charging device (10) for charging the traction battery (2) according to the method and to a motor vehicle (4) with such a charging device (10).

### FIELD OF THE INVENTION

The invention relates to a method for charging a traction battery of an electrically powered motor vehicle. Furthermore, the invention relates to a charging device and a motor vehicle having such a device.

### BACKGROUND OF THE INVENTION

An electrically powered motor vehicle typically has a traction battery which supplies an electric motor with energy for powering the motor vehicle. The term “electrically powered motor vehicles” means in particular an electric vehicle that stores the energy required to power it only in the traction battery (BEV, battery electric vehicle), an electric vehicle with a range extender (REEV, range extended electric vehicle), a hybrid vehicle (HEV, hybrid electric vehicle) or a plug-in hybrid vehicle (PHEV, plug-in hybrid electric vehicle).

Such a traction battery typically undergoes irreversible aging processes which disadvantageously result in a reduction in the capacity and/or the maximum output of the traction battery.

The so-called calendar aging of the traction battery is influenced in particular by the temperature of the traction battery and its state of charge (SOC). The aging processes take place more quickly at a comparatively high temperature of the traction battery and/or at a comparatively high battery charge level than at lower temperatures or a lower battery charge level. For example, the so-called “Solid Electrolyte Interphase” (SEI), i.e. a passivating boundary layer between the anode and the electrolyte of the traction battery, is formed comparatively quickly due to the decomposition of the electrolyte at high temperatures and/or with a high battery charge level.

On the one hand, such aging processes are disadvantageous for the service life of the traction battery; on the other hand, a user of the motor vehicle often wishes to have a long range at the start of the journey, and consequently a high battery charge level.

The invention has for its object to provide a suitable charging process for a traction battery of an electrically powered motor vehicle. In particular, aging of the traction battery is to be avoided or at least delayed and/or the traction battery is to be charged to a battery charge level desired by the user. Furthermore, a charging device for charging the traction battery according to the method and a motor vehicle with such a charging device are to be specified.

With regard to the method, the object is achieved according to the invention by the features of certain independent claims. With regard to the charging device, the object is achieved according to the invention with the features of other independent claims and with respect to the motor vehicle with the features of still other independent claims. Advantageous embodiments and developments are the subject-matter of the dependent claims. The explanations in connection with the method also apply mutatis mutandis to the charging device and to the motor vehicle and vice versa.

The method is intended and suitable for charging a traction battery of an electrically powered motor vehicle. Here, a first target value for a first battery charge level is specified, which the traction battery should have at a (future) start of the journey of the motor vehicle. In particular, the first target value is specified by a user. As an alternative to this, the first target value is stored, for example, on a charging device that controls the charging of the traction battery, or is determined by the charging device on the basis of an input from the user, for example a range of the motor vehicle specified by the user, and is then specified. Further alternatively, the first target value is determined by a further vehicle-external or vehicle-internal device, transmitted to the charging device and then specified. For example, the first target value is determined by a back-end of a navigation system on the basis of a predefined route and a quantity of energy required for this, and is transmitted to the charging device.

The traction battery, if its battery charge level is smaller than a second target value when connected to a charging station, is charged in a first charging process to a second battery charge level, which second battery charge level corresponds to the second target value. The first charging process is preferably carried out immediately after the traction battery has been connected to the charging station, that is to say immediately after the traction battery has been connected to the charging station. The charging station is, for example, a charging station or a so-called wall box, the charging station providing or being able to provide a charging voltage or a charging current suitable for charging the traction battery.

In a further step of the method, the traction battery is charged to the first battery charge level corresponding to the first target value in a second charging process. The traction battery is thus charged from the second battery charge level to the first battery charge level in the course of the second charging process, provided the traction battery was charged to the second battery charge level in the course of the first charging process. Otherwise, the traction battery is charged in the course of the second charging process from the battery charge level, which the traction battery had when it was connected to the charging station, to the first battery charge level.

According to a first variant of the method, the start time of the second charging process is set as a function of a specific (forecast) departure time and as a function of the first target value. Furthermore, the second target value or the (connection) battery charge level which the traction battery had when it was connected to the charging station is also used to determine the start time. In particular, the start time is based on a necessary period of time for charging the traction battery from the second battery charge level and to the first battery charge level or for charging from the (connection) battery charge level to the first battery charge level. In particular, this period of time is further dependent on a charging power that can be provided by the charging station, on a limitation for the charging power specified, for example, by a battery management system, and/or on the ambient temperature.

The start time of the second charging process is particularly preferably set such that the aging processes mentioned at the outset are avoided or at least reduced as far as possible. For this purpose, in particular the time period between the end of the first charging process and the start time of the second charging process is maximized and/or an aging parameter which characterizes the aging processes of the traction battery and can be determined on the basis of this time period and the amount of the second battery charge level is minimized. The second charging process is expediently delayed in such a way that the end of the second charging process coincides with the determined departure time and the traction battery is charged to the first battery charge level.

According to a second variant of the method, the second charging process is started on the basis of a start signal which is output by this terminal as a result of an interaction of the user of the motor vehicle with a terminal. In particular, the start signal is transmitted to the charging device and the second charging process of the traction battery is initiated by the charging device. In summary, the start of the second charging process is, therefore, effected on the basis of an actual action and not on an action forecast by the user. The (probable) departure time is expediently also determined and the second charging process, in particular the charging current, is set such that the end of the second charging process coincides with the determined departure time and the traction battery is charged to the first battery charge level.

Here, a (data) terminal is to be understood as a device which can be connected to a network termination of a telecommunications network, for example the Internet. A terminal is also to be understood in particular to mean a mobile terminal such as a smartphone, a tablet, a laptop or the like. At most, the terminal can be coupled to the charging device in terms of signal transmission technology. This coupling takes place, for example, directly, i.e. the start signal is transmitted directly from the terminal to the charging device. Alternatively, the start signal is transmitted indirectly, for example by means of a backend from the vehicle manufacturer, which in turn can be coupled to the charging device for signal transmission purposes, or by means of a central control unit of a so-called smart home system.

In both variants of the method, the second battery charge level is smaller than the first battery charge level. In other words, the amount of energy stored in the traction battery in the second battery charge level is smaller than in the first battery charge level. In particular, the second battery charge level is thus smaller than the first battery charge level desired by the user at the start of the journey. As a result, calendar aging due to a comparatively high battery charge level is avoided or at least reduced for the period in which the battery charge level is smaller than the first battery charge level. In summary, downtimes of the motor vehicle are avoided during which the traction battery has a comparatively high battery charge level.

Furthermore, due to the setting of the start time of the second charging process as a function of the specific departure time and the first target value or due to the start of the second charging process as a result of a start signal, the time period between the end of the first charging process or the time of connecting the traction battery to the charging station, provided that it is not charged to the second battery charge level, and the start time of the second charging process is comparatively long. Consequently, the calendar aging of the traction battery is advantageously avoided or at least reduced for this comparatively long period of time.

For example, the second target value is specified. According to an advantageous development of both variants of the method, however, the second target value is determined as a function of the first target value. In comparison to a constantly predetermined second target value, it is possible in this way to reduce, in particular to minimize, the second target value and, consequently, the second battery charge level, and consequently to further avoid any aging processes. The second target value is suitably reduced with a comparatively small first target value.

In the case of the method according to the first variant, the second target value is determined additionally or alternatively as a function of the specific (predicted) departure time. In the case of the method according to the second variant, the departure time is additionally or alternatively first determined (predicted) and then the second target value is determined as a function thereof. The second target value and correspondingly the second battery charge level are expediently determined and expediently subsequently specified such that the time period between the end of the first charging process and the start time of the second charging process is maximized, the amount of the second battery charge level is minimized and/or an aging parameter, which can be determined based on this time period and the, in particular minimized, amount of the second battery charge level, which characterizes the aging processes of the traction battery, is minimized. In particular, the second target value is suitably reduced in the case of a comparatively long period of time between the time the traction battery is connected to the charging station and the determined departure time.

For example, a minimum amount is provided for the second target value, so that the motor vehicle can also be used by the user with a minimum range corresponding to at least the minimum amount before the second charging process is completed.

According to a suitable embodiment, data from previous actual departure times and/or information from previous start signals are used to determine the departure time. This data and information is also referred to as historical data or historical information. Using these data and information, the habits of the user can be taken into account in order to determine the (predicted) departure time, and thus the departure time can be determined comparatively precisely. In particular, a typical or average departure time of the previous actual departure times is used to forecast the departure time or, alternatively, a typical or an average time period between the time of the transmission of the start signal and the corresponding actual departure times is used.

According to an advantageous development, the temperature of the traction battery is set in the course of charging to the second battery charge level, that is to say in the course of the first charging process, in the course of charging to the first battery charge level, that is to say in the course of the second charging process, and/or in time between these charging processes that a predetermined or predeterminable maximum temperature is not exceeded. For this purpose, for example, a charging current is set accordingly and, additionally or alternatively, a cooling device of the motor vehicle is used to cool the traction battery. As a result, calendar aging due to a comparatively high temperature is advantageously avoided or at least reduced.

According to an advantageous embodiment, the charging device for charging the traction battery of the electrically powered motor vehicle is provided and set up in accordance with the method according to one of the embodiments shown above. For this purpose, the charging device has a measuring device for detecting the (current) battery charge level of the traction battery of the motor vehicle. Furthermore, the charging device has a control unit for controlling the first charging process and/or for controlling the second charging process. In terms of circuitry and programming technology, the control unit is set up so that the traction battery is charged in accordance with the method described above. In particular, the control unit is provided and set up for starting the second charging process, in particular on the basis of the determination of the start time on the basis of the determination of the first target value and the specific departure time or on the basis of the start signal, and for determining the second target value.

If the charging device is provided for charging the traction battery according to the method according to the second variant, according to which the second charging process is started on the basis of a start signal, the charging device expediently has a receiver for the start signal, for example a so-called online connected unit (OCU).

For example, the charging device furthermore has a temperature sensor or an interface to such a temperature sensor, so that the temperature of the traction battery is detected and the charging current or a cooling device is set or operated accordingly.

According to an expedient development, an electrically powered motor vehicle has a charging device in one of the variants shown above. As an alternative to this, the charging device is part of the charging station, in other words the charging device is then integrated into the charging station.

### BRIEF DESCRIPTION OF THE DRAWINGS

Exemplary embodiments of the invention are explained in more detail below with reference to a drawing. In it show:

FIG. 1a is a flowchart which represents a first variant of a method for charging a traction battery of an electrically powered motor vehicle, the traction battery first being charged to a second battery charge level, with a start time being determined for a second charging process and the second charging process being started at this start time,

FIG. 1b is a time battery charge level diagram for charging a traction battery according to the first variant of the method,

FIG. 2a is a flowchart which represents a second variant of the method for charging the traction battery of the electrically powered motor vehicle, the traction battery being initially charged to the second battery charge level, and the second charging process being started as a result of a start signal,

FIG. 2b is a time battery charge level diagram for charging the traction battery according to the second variant of the method, and

FIG. 3 is an electrically powered motor vehicle with the traction battery and with a charging device connected to it, the charging device being connected to a charging station and having a receiver for signal transmission coupling with a terminal.

Corresponding parts and sizes are always provided with the same reference symbols in all figures.

### DETAILED DESCRIPTION OF THE INVENTION

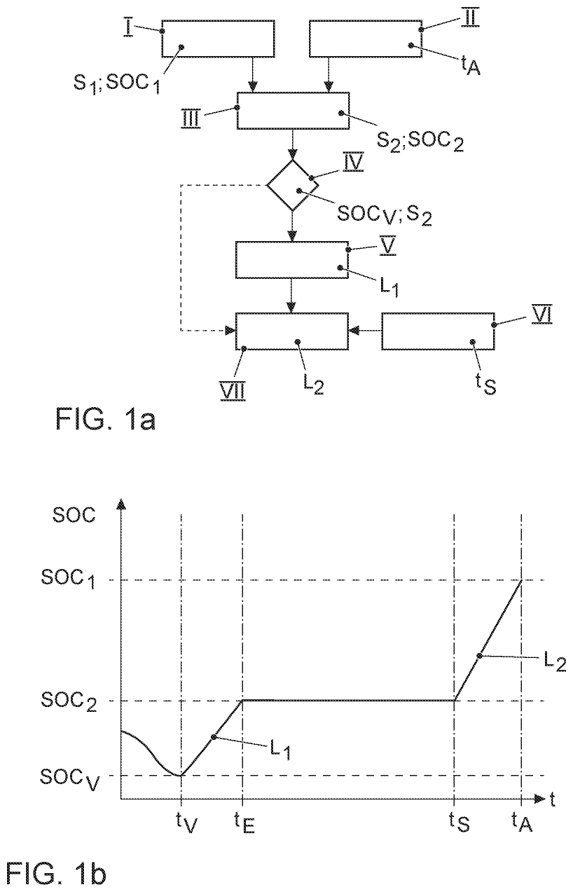

In FIG. 1a a flow chart is shown which illustrates a first variant of a method for charging a traction battery 2 of an electrically powered motor vehicle 4. In FIG. 1b, a time battery charge level diagram corresponding thereto is shown, wherein the time t is plotted against the abscissa, and the battery charge level SOC of traction battery 2 is plotted against.

Here, in a first step I, a first target value S₁ for a first battery charge level SOC₁ is specified, which the traction battery 2 should have at the start of the journey. This is, for example, 80%. This first target value S₁ is predetermined by a user or determined on the basis of a specification or input by the user, for example a range desired by the user or the selection of an operating mode of the motor vehicle 4, such as an operating mode for daily use.

In a second step II, an (expected) departure time t_{A} of the motor vehicle 4 is determined (predicted). For this purpose, data of previous actual departure times are used, a typical or average departure time of the previous actual departure times being determined and used as a specific departure time t_{A}.

On the basis of the first target value S₁ and the predicted (determined) departure time t_{A}, a second target value S₂ for a second battery charge level SOC₂ is determined in a further third step III, on which the traction battery 2 initially should be charged. The second battery charge level SOC₂ is smaller than the first battery charge level SOC₁ corresponding to the first target value.

As shown in FIG. 1b, the motor vehicle 4—and thus the traction battery 2—is connected to a charging station 6 at time t_{V}, that is to say connected to it. The battery charge level SOC_{V} at this time t_{V} is compared with the second target value S₂ (fourth step IV). If the battery charge level SOC_{V} is smaller than the second target value S₂ at the time t_{V}, the traction battery 2 is charged to the second battery charge level SOC₂ in a first charging process L₁ (fifth step V). The first charging process L₁ ends at time t_{E}. For example, the second battery charge level is 50%.

In a further (sixth) step VI, a start time t_{S} is determined for a second charging process L₂. The start time t_{S} is determined in such a way that the traction battery 2 has the first battery charge level SOC₁ due to the second charging process L₂ as precisely as possible at the predicted departure time t_{A}. Here, the start time t_{S} based on the predicted departure time t_{A} and a period of time necessary for charging the traction battery 2 results from the second battery charge level SOC₂ which corresponds to the second target value S₂ and from the first battery charge level SOC₁ which corresponds to the first target value S₁ or for charging from the battery charge level SOC_{V} to the first battery charge level SOC₁, provided that the traction battery 2 was not charged to the second battery charge level SOC₂ in the fourth step IV. In summary, the start time t_{S} is determined and set as a function of the determined (predicted) departure time t_{A} and as a function of the first target value S₁.

The second charging process L₂ takes place in a seventh step VII. The traction battery 2 is charged accordingly from the second battery charge level SOC₂ to the first battery charge level SOC₁ and/or from the battery charge level SOC_{V} at time t_{V} to the first battery charge level SOC₁, which is shown in broken lines in FIG. 1a.

In summary, the traction battery 2 is not charged directly to the first battery charge level SOC₁. Rather, the traction battery 2 is first charged to the second battery charge level SOC₂, which is smaller in comparison to the first battery charge level SOC₁, so that a period of time of the motor vehicle with a comparatively high battery charge level is avoided. As a result, calendar aging of the traction battery is also avoided or at least reduced.

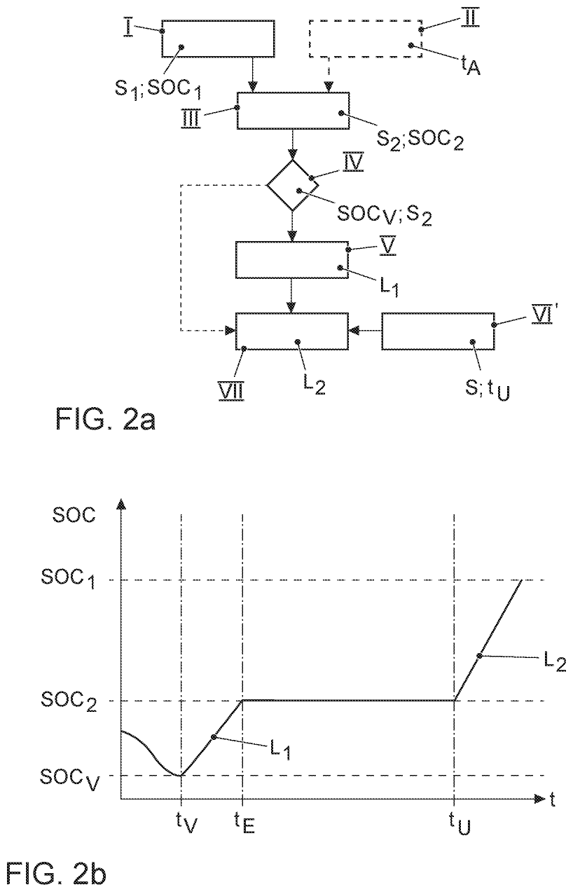

In FIG. 2a, a flow diagram is shown which shows a second variant of the method for charging the traction battery 2 and a time battery charge level diagram corresponding thereto shown in FIG. 2b. Steps I through IV and, if applicable, step V are carried out analogously to the first variant according to FIGS. 1a and 1b.

According to an alternative embodiment of the second variant of the method, the second target value S₂ is determined in step III only as a function of the first target value S₁, that means not as a function of the predicted departure time t_{A}. Consequently, step II, that means the forecast of the (expected) departure time t_{A} is not necessary, which is why this step is shown in broken lines in FIG. 2a.

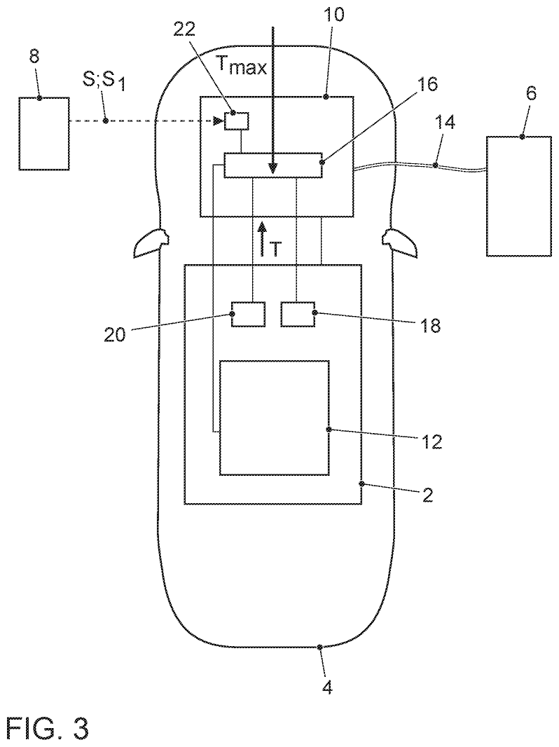

In step VI′, a user of the motor vehicle 4 interacts with a terminal 8 (cf. FIG. 3), as a result of which a start signal S is output by the terminal 8 and transmitted to a charging device 10. As can be seen in FIG. 2b, this start signal S is received by the charging device 10 at the time t_{U} and the start of the second charging process L₂ is effected, in other words initiated. The traction battery 2 is charged to the first battery charge level SOC₁ (step VII). Thus, the traction battery 2 is charged in time directly after the reception of the start signal S from the second battery charge level SOC₂ or from the battery charge level SOC_{V} to the first battery charge level SOC₁.

In both variants of the method, the temperature T of the traction battery 2 is recorded in the course of the first charging process L₁, in the course of the second charging process L₂ and in the time between these two charging processes, that means between the time t_{E} and the time t_{A} or t_{U}. In order to avoid the calendar aging of the traction battery 2 due to a comparatively high temperature, the temperature T of the traction battery 2 is set such that a predetermined or predeterminable maximum temperature Tₘₐₓ, for example 22° C., is not exceeded. For this purpose, a charging current for charging the traction battery 2 is selected accordingly and, additionally or alternatively, a cooling device 12 for the traction battery 2 is activated (cf. FIG. 3).

FIG. 3 shows the electrically powered motor vehicle 4. This has the traction battery 2, which is connected to the charging device 10 of the motor vehicle 4. The charging device 10 is set up so that the traction battery 2 is charged according to one of the variants of the method according to FIGS. 1a to 2b. For this purpose, the motor vehicle 4 and in particular its charging device 10 is connected to the charging station 6 by means of a charging cable 14, which is designed here as an example of a charging station. The charging station 6 provides a charging voltage suitable for charging the traction battery 2 or a charging current suitable for this. Furthermore, the charging device 10 has a control unit 16. This regulates or controls the amount and the time profile of the charging current supplied to the traction battery 2 or corresponding to the charging voltage applied to the traction battery 2. In summary, the control unit 16 controls the first and the second charging process L₁ and L₂.

The charging device 10 furthermore has a measuring unit 18, by means of which the battery charge level SOC of the traction battery 2 can be determined.

The motor vehicle 4 has the cooling device 12, by means of which the traction battery 2 can be cooled, so that the maximum temperature Tₘₐₓ is not exceeded. The cooling device 12 can be controlled by the control device 16, the maximum temperature Tₘₐₓ being stored on the control unit, and the control unit 16 being connected to a temperature sensor 20 for detecting the temperature T of the traction battery 2.

The charging device 10 furthermore comprises a receiver 22 connected to the control unit 16 for receiving the start signal S output by the terminal 8. In particular, the terminal 8 has a functionality which is additionally provided for initiating the second charging process L₂. For example, the terminal 8 is a smartphone which, when the user interacts with the terminal 8, for example when an alarm function is switched off, outputs a so-called push message as the start signal S and transmits it to the receiver 22.

Furthermore, the first target value S₁ is specified by the user (not shown) by means of the terminal 8 and transmitted to the charging device 10.

The invention is not restricted to the exemplary embodiments described above. Rather, other variants of the invention can also be derived therefrom by a person skilled in the art without leaving the subject-matter of the invention. In particular, all of the individual features described in connection with the exemplary embodiments can also be combined with one another in other ways without departing from the subject-matter of the invention.

### REFERENCE LIST

2 traction battery
4 motor vehicle
6 charging station
8 terminal
10 charging device
12 cooling device
14 charging cable
16 control unit
18 measuring device
20 temperature sensor
22 receiver
I specification of the first target value
II determination of the departure time
III determination of the second target value
IV comparison of the second target value with the battery charge level
V first charging process
VI determination of the start time of the first charging process
VI′ output of the start signal
VII second charging process
L₁ first charging process
L₂ second charging process
S start signal
S₁ first target value
S₂ second target value
SOC battery charge level
SOC_{V} battery charge level at the time t_{V}
SOC₁ first battery charge level
SOC₂ second battery charge level
t time
t_{A} departure time
t_{E} end time of the first charging process
t_{S} start time of the second charging process
t_{U} time of receipt of the start signal
t_{V} time of connection of the charging device to the charging station
T temperature of the traction battery
Tₘₐₓ maximum temperature of the traction battery

1. A method for charging a traction battery (2) of an electrically powered motor vehicle (4), comprising:
specifying a first target value (S₁) for a first battery charge level (SOC₁) for a start of the journey of the motor vehicle (4),
charging the traction battery, provided that its battery charge level (SOC_{V}) is smaller than a second target value (S₂), to avoid aging processes, in a first charging process (L₁) to a second battery charge level (SOC₂) which corresponds to a second target value (S₂), which second battery charge level (SOC₂) is smaller than the first battery charge level (SOC₁), and
charging the traction battery (2) to the first battery charge level (SOC₁) in a second charging process (L₂),
whereby the start time (t_{S}) of the second charging process (L₂) is set as a function of a specific departure time (t_{A}) of the first target value (S₁) and the second target value (S₂), or
whereby the second charging process (L₂) is started on the basis of a start signal (S), which is output as a result of an interaction of the user with a terminal (8).

2. The method according to claim 1, further comprising determining the second target value (S₂) as a function of the first target value (S₁) and/or as a function of the departure time or a specific departure time (t_{A}).

3. The method according to claim 1, wherein data of previous departure times and/or information of previous start signals are used to determine the departure time (t_{A}).

4. A method according to claim 1, further comprising, in order to avoid aging processes of the traction battery (2), setting its temperature (T) in the course of charging to the second battery charge level (SOC₂), in the course of charging to the first battery charge level (SOC₁) and/or in time between these charging processes that a predetermined or predeterminable maximum temperature (Tₘₐₓ) is not exceeded.

5. The charging device (10) for charging a traction battery (2) of an electrically powered motor vehicle (4) according to the method of claim 1, comprising:
a measuring device (18) for detecting the battery charge level (SOCA) of the traction battery (2) of the motor vehicle (4), and
a control unit (16) for controlling the first charging process (L₁) and/or for controlling the second charging process (L₂).

6. A motor vehicle (4) with a charging device (10) according to claim 5.
